(19) United States
(12) Patent Application Publication
(10) Pub. No.: US 2021/0323729 A1
(43) Pub. Date: Oct. 21, 2021

(54) Peelable Sandwich Bag

(71) Applicant: Bernard Douglas Stribbling, Adamstown, MD (US)

(72) Inventor: Bernard Douglas Stribbling, Adamstown, MD (US)

(21) Appl. No.: 16/852,476

(22) Filed: Apr. 18, 2020

(51) Int. Cl. B65D 33/16; B65D 85/00; B65D 81/18

(52) U.S. Cl. CPC B65D 33/16; B65D 81/18; B65D 85/70

(57) ABSTRACT

This design for a peelable sandwich bag facilitates the consumption of a sandwich without having to directly touch the sandwich. The bag consists of two stacked rectangular layers that are sealed together at the bottom edge and only partly sealed on the side edges starting from the bottom. This creates three free edges that peel away from the sandwich during consumption. A plurality of magnetic strips mounted near the free edges enables the enclosure of the bag around the sandwich prior to consumption. The combination of temperature resistant plastic and sufficiently weighty magnets enables the sandwich bag to be dishwasher safe and reusable.

### SUMMARY OF THE INVENTION

The object of the present invention is to provide a reusable sandwich bag that enables one to easily consume a sandwich without ever having to directly touch it. This simple measure prevents hand germs from being transferred to the mucosal layers where most pathogens enter the body prior to infection. Toward this end, the invention consists of a resealable flat plastic bag that opens along three edges and this enables the two layers of the bag to separate from each other as well as the contents of the bag. This feature permits a sandwich to be easily consumed without ever having to directly touch it. Each portion of the sandwich can be exposed by simply peeling each layer away from said portion while holding onto the unexposed portion through the bag.

To make such a bag reusable, it needs to be durable and easy to clean. Thus the bag should consist of a thick, high temperature plastic that can stand up to the rigors of a dishwasher. It must further possess sufficient weight so that when it is placed over the tines of a dishwasher rack it is not thrown out of place by the power of the water jets. This weight is to be provided by the preferred sealing mechanism. This sealing mechanism uses a series of self-aligning strip magnets that are mounted along the three free edges of the bag.

### BRIEF DESCRIPTION OF THE DRAWINGS

An embodiment of the present invention will now be described by way of an example and with reference to the accompanying drawings, in which:

FIG. 1 illustrates a perspective view of the partially open three-edged sandwich bag with three long magnetic strips sealing the edges.

FIG. 2 illustrates a perspective view of the partially open three-edged sandwich bag filled with a sandwich.

FIG. 3 illustrates a perspective view of the three-edged sandwich bag with a pair of sleeves at the top for holding in place removable magnetic strips.

FIG. 4 illustrates a perspective view of the three-edged sandwich bag being rolled up once the top strips are removed.

FIG. 5 illustrates a perspective view of the three-edged sandwich bag with pockets

FIG. 6 illustrates a perspective view of the three-edged sandwich bag with a multiplicity of smaller magnetic strips.

### DETAILED DESCRIPTION

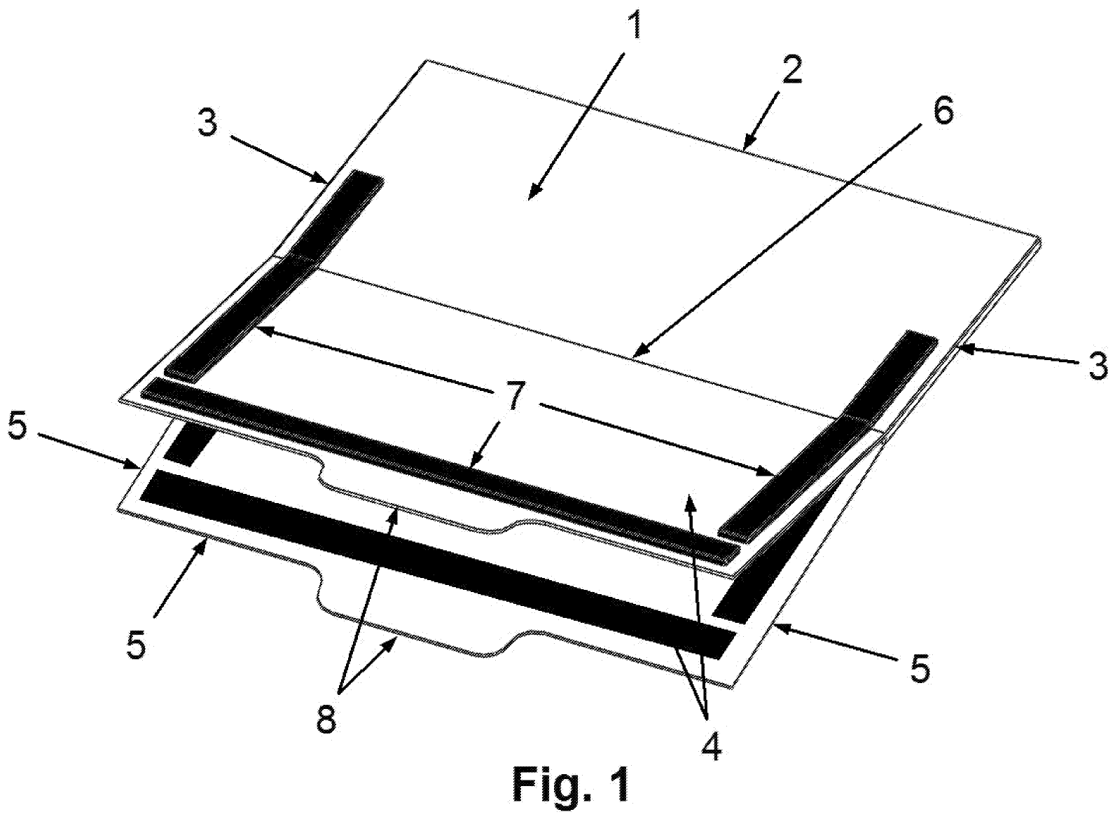

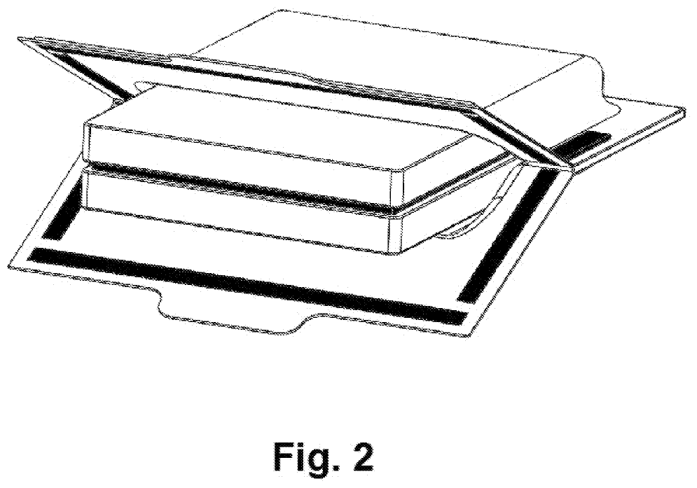

The preferred embodiment of the three-edged sandwich bag is shown in FIG. 1. A flat rectangular bag 1 consists of two stacked layers of plastic sheeting that are permanently sealed together at the bottom edge 2 and this permanent seal also extends along the two side edges 3 adjacent to the bottom edge 2. The permanent seal along the side edges 3 ends at approximately ⅓ of the height from the bottom. This design leaves two free layers 4 on the upper portion of the bag 1 with three edges 5 that are not permanently affixed. The junction line 6 where the sealed layers and free layers 4 meet lies in the lower portion of the bag 1 to permit sufficient access to the sandwich when the free layers 4 peel away from it. The three edges 5 close by pairing a multi-polar magnetic strip 7 on one layer with a counterpart on the opposite layer. For both layers, the multi-polar magnetic strips 7 are attached to the outside of the bag using a permanent adhesive. Three pairs of magnetic strips 7 are necessary to close the three edges 5. Additionally, to ease separation of the free edges 5, protruding tabs 8 are located at the central top edges of the free layers 4. FIG. 2 shows the three-edged sandwich bag with a sandwich inserted.

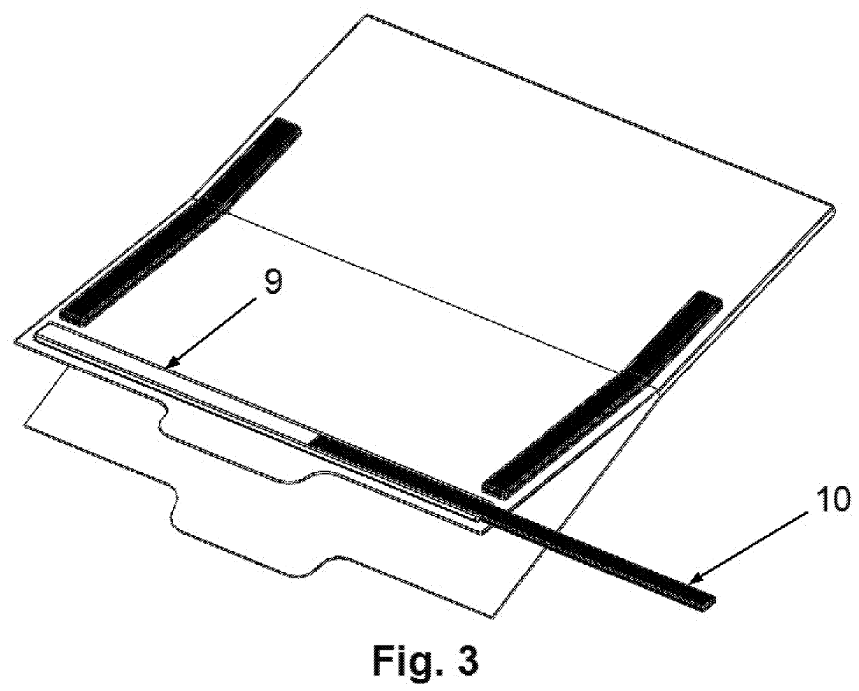

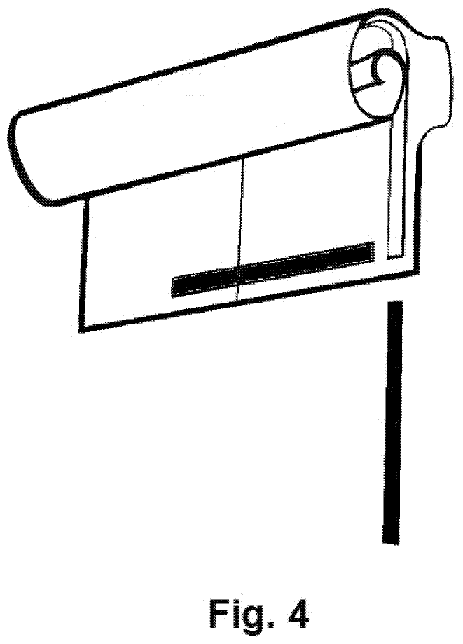

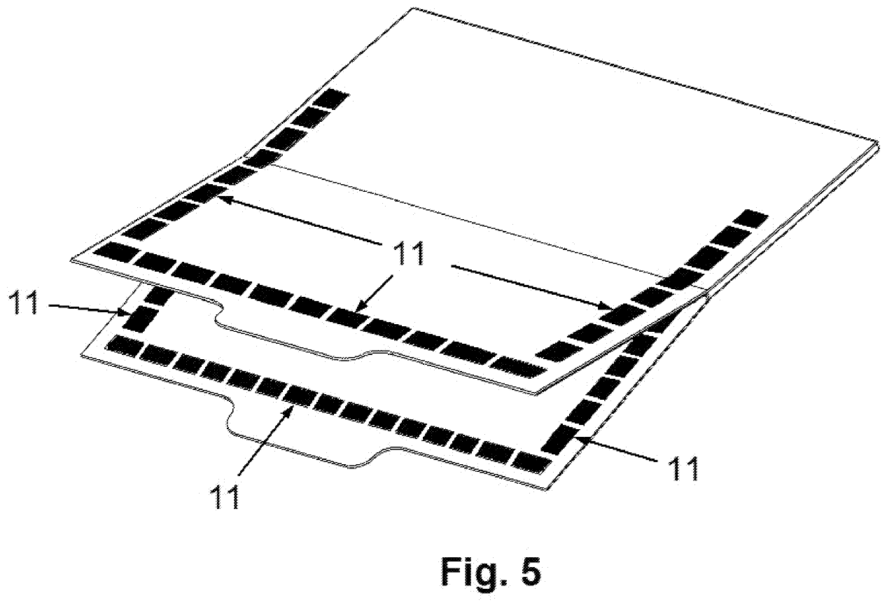

FIG. 3 demonstrates a variation on the closure mechanism. Instead of using a permanently affixed multi-polar magnetic strip for the top edge of the bag, a sleeve 9 is affixed to the top edge and into which a loose multi-polar magnetic strip 10 is inserted for closure purposes. This variation enables the loose multi-polar magnetic strip 10 to slide out from the sleeve 9 after the sandwich is consumed. The loose strip is then placed on top of one of the permanently affixed side magnets and, as is shown in FIG. 4, the whole bag can now easily be rolled from one of the sides into a tight bundle for easy stowing. FIG. 5 shows another variation on the closure mechanism. It utilizes multiple short, tightly spaced multi-polar magnetic strip magnets 11 in lieu of three whole strips. This design also enables an easy role of the bag into a tight bundle and the roll can start from top, bottom, left or right.

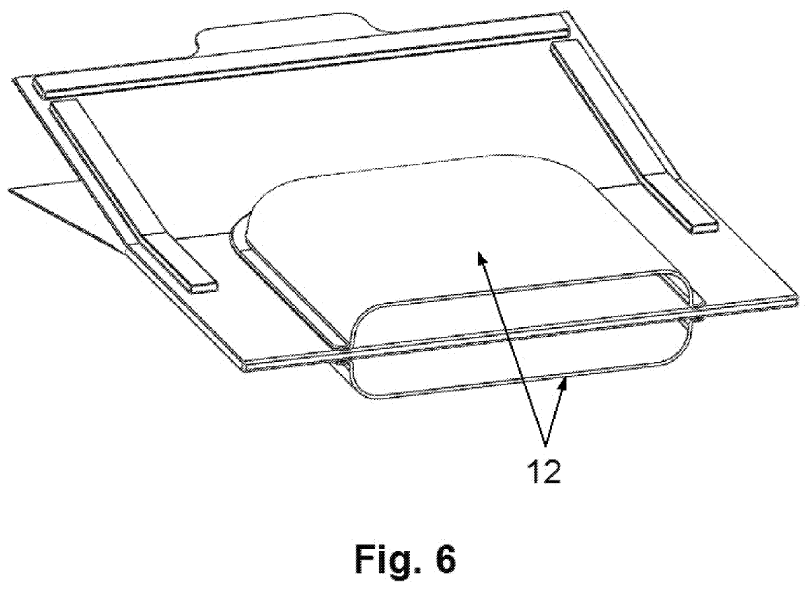

An additional element is shown in FIG. 6 where the three-edged sandwich bag is equipped with pockets 12 that have openings directed toward the bottom of the three-edged sandwich bag. Alternatively, the pockets could have openings directed towards the top. These pockets 12 can serve either of two purposes: (1) one or both hands with the fingers inserted in one pocket and the thumbs inserted in the opposite pocket enables the opening of the bag without having to touch the top of the bag; and (2) hot or cold packs can be inserted into the pockets to regulate sandwich temperature.

I claim:

1. A bag consisting of two stacked rectangular layers of identical dimensions that are permanently sealed together along the entire length of one of the four edges and this sealed edge defines the bottom of the bag; the two side edges and top edge of each layer are free edges in that they lack any permanent seal to the opposite layer; and the free edges of each layer possess a means of repeatably joining and separating the free edges of the opposite layer so as to enclose, store and then remove a sandwich or other food item within the bag.

2. A bag consisting of two stacked rectangular layers of identical dimensions that are permanently sealed together along the entire length of one of the four edges and this sealed edge defines the bottom of the bag; the two side edges and top edge of each layer are free edges in that they lack any permanent seal to the opposite layer; and permanently affixed along the free edges of each layer are permanent magnets that are oriented and aligned so as to permit stacking of the magnets on each layer with its counterpart on the opposite layer and this combination enables a repeatable joining and separating of the free edges of each layer to enclose, store and then remove a sandwich or other food item within the bag.

3. A food storage bag comprised of two stacked rectangular layers of identical dimensions that are permanently sealed together along the entire length of one of the four edges and the remaining three edges of each layer are free edges in that they lack any permanent seal to the opposite layer; and the free edges of each layer adhere to the opposite layer with strip magnets inserted into sleeves that run along the length of one, two, or all three of the free edges of each layer.

4. A bag as in claim 1, with one or more pockets for either hand placement or the storage of hot and cold packs.

5. A bag as in claim 1, in which the means of repeatably joining and separating with the free edges of the opposite layer uses multi-polar permanent strip magnets.

6. A bag as in claim 2, with one or more pockets for either hand placement or the storage of hot and cold packs.

7. A bag as in claim 2, in which the means of repeatably joining and separating with the free edges of the opposite layer uses multi-polar permanent strip magnets.

8. A bag as in claim 3, with one or two pockets, distinct from the sleeves holding the strip magnets, centered in between the sealed edge and the free edges, open only to the exterior of the bag and possessing dimensions that permit the insertion of hot or cold packs.

9. A bag as in claim 3, in which the strip magnets are multi-polar.
